(19) United States
(12) Patent Application Publication
(10) Pub. No.: US 2026/0359284 A1
(43) Pub. Date: Nov. 12, 2026

(54) SYSTEMS AND METHODS FOR INTELLIGENT DATA REPLICATION

(71) Applicant: Truist Bank, Charlotte, NC (US)

(72) Inventors: Kamal Chandna, Charlotte, NC (US); Pradeep Mugundu Sugadev, Charlotte, NC (US); Prashant Sogarwal, Charlotte, NC (US); Sanjay Pattanayak, Charlotte, NC (US); Sumit Goyal, Charlotte, NC (US)

(73) Assignee: Truist Bank, Charlotte, NC (US)

(21) Appl. No.: 19/203,514

(22) Filed: May 9, 2025

(51) Int. Cl. G06F 16/23

(52) U.S. Cl. CPC G06F 16/2365; G06F 16/2358

(57) ABSTRACT

A method, computer program product, and computer system for receiving, by a computing device, data from a source. How the data maps to a target that is remote from the source may be defined. At least a portion of the data for change events may be monitored. At least the portion of the data for the change events may be scanned to identify sensitive elements. On-the-fly tokenization of at least the portion of the data for the change events identified as the sensitive elements may be provided. A replication key for the on-the-fly tokenization may be compared against a last stored value. At least the portion of the data may be eliminated when the replication key matches the last stored value. At least the portion of the data may be stored at the target when the replication key is different than the last stored value.

### TECHNICAL FIELD

The present disclosure relates generally to database replication and, more particularly, to techniques for securely and efficiently synchronizing large volumes of on-premises relational data with cloud-based data warehouses in real time.

### BACKGROUND

Modern enterprises frequently maintain critical business data in on-premises data stores (e.g., relational database management systems (RDBMS) and similar platforms). To support analytics, reporting, and cross-enterprise data sharing, it has become common practice to replicate- or “ship”-changes from these operational systems into cloud data warehouses. Traditional replication approaches rely on Extract-Transform-Load (ETL) pipelines that periodically bulk-export full table snapshots or deltas, persist them to intermediate storage, then re-load them into the target.

### SUMMARY

In one example implementation, a computer-implemented method, performed by one or more computing devices, may include but is not limited to receiving, by a computing device, data from a source. How the data maps to a target that is remote from the source may be defined. At least a portion of the data for change events may be monitored. At least the portion of the data for the change events may be scanned to identify sensitive elements. On-the-fly tokenization of at least the portion of the data for the change events identified as the sensitive elements may be provided. A replication key for the on-the-fly tokenization may be compared against a last stored value. At least the portion of the data may be eliminated when the replication key matches the last stored value. At least the portion of the data may be stored at the target when the replication key is different than the last stored value.

One or more of the following example features may be included. The change events may be batch processed into configurable chunks. The configurable chunks may be configurable by at least one of row batches and intervals. The batch processing may pause reads if a next stage is busy. The batch processing may replay failed batches using an exactly-once token. The batch processing may maintain event ordering per partition. Monitoring at least the portion of the data for change events may include generating a subscription for the change events. Monitoring at least the portion of the data for the change events may include creating a change-stream definition to identify at least the portion of the data to monitor for changes. Scanning at least the portion of the data for the change events to identify the sensitive elements may include flagging the sensitive elements using machine learning based classifiers to detect sensitive fields. Scanning at least the portion of the data for the change events to identify the sensitive elements may include flagging the sensitive elements using pattern recognition for known ID formats to detect sensitive fields. Scanning at least the portion of the data for the change events to identify the sensitive elements may include flagging the sensitive elements using context-aware classifiers to detect sensitive fields. Providing on-the-fly tokenization of at least the portion of the data for the change events identified as the sensitive elements may include triggering a tokenization application programming interface (API) in real-time. Providing on-the-fly tokenization of at least the portion of the data for the change events identified as the sensitive elements may include selecting a format-preserving encryption. Providing on-the-fly tokenization of at least the portion of the data for the change events identified as the sensitive elements may include selecting a random surrogate token stored in a vault. Providing on-the-fly tokenization of at least the portion of the data for the change events identified as the sensitive elements may include eliminating persistent cleartext copies. Comparing a replication key for the on-the-fly tokenization against the last stored value may include hashing a minimal set of business keys and change-timestamps. Storing at least the portion of the data at the target when the replication key is different than the last stored value may include issuing an insert into a live table for at least the portion of the data at the target. Storing at least the portion of the data at the target when the replication key is different than the last stored value may include issuing an update into a live table for at least the portion of the data at the target.

In another example implementation, a computing system may include one or more processors and one or more memories configured to perform operations that may include but are not limited to receiving, by a computing device, data from a source. How the data maps to a target that is remote from the source may be defined. At least a portion of the data for change events may be monitored. At least the portion of the data for the change events may be scanned to identify sensitive elements. On-the-fly tokenization of at least the portion of the data for the change events identified as the sensitive elements may be provided. A replication key for the on-the-fly tokenization may be compared against a last stored value. At least the portion of the data may be eliminated when the replication key matches the last stored value. At least the portion of the data may be stored at the target when the replication key is different than the last stored value.

One or more of the following example features may be included. The change events may be batch processed into configurable chunks. The configurable chunks may be configurable by at least one of row batches and intervals. The batch processing may pause reads if a next stage is busy. The batch processing may replay failed batches using an exactly-once token. The batch processing may maintain event ordering per partition. Monitoring at least the portion of the data for change events may include generating a subscription for the change events. Monitoring at least the portion of the data for the change events may include creating a change-stream definition to identify at least the portion of the data to monitor for changes. Scanning at least the portion of the data for the change events to identify the sensitive elements may include flagging the sensitive elements using machine learning based classifiers to detect sensitive fields. Scanning at least the portion of the data for the change events to identify the sensitive elements may include flagging the sensitive elements using pattern recognition for known ID formats to detect sensitive fields. Scanning at least the portion of the data for the change events to identify the sensitive elements may include flagging the sensitive elements using context-aware classifiers to detect sensitive fields. Providing on-the-fly tokenization of at least the portion of the data for the change events identified as the sensitive elements may include triggering a tokenization application programming interface (API) in real-time. Providing on-the-fly tokenization of at least the portion of the data for the change events identified as the sensitive elements may include selecting a format-preserving encryption. Providing on-the-fly tokenization of at least the portion of the data for the change events identified as the sensitive elements may include selecting a random surrogate token stored in a vault. Providing on-the-fly tokenization of at least the portion of the data for the change events identified as the sensitive elements may include eliminating persistent cleartext copies. Comparing a replication key for the on-the-fly tokenization against the last stored value may include hashing a minimal set of business keys and change-timestamps. Storing at least the portion of the data at the target when the replication key is different than the last stored value may include issuing an insert into a live table for at least the portion of the data at the target. Storing at least the portion of the data at the target when the replication key is different than the last stored value may include issuing an update into a live table for at least the portion of the data at the target.

In another example implementation, a computer program product may reside on a computer readable storage medium having a plurality of instructions stored thereon which, when executed across one or more processors, may cause at least a portion of the one or more processors to perform operations that may include but are not limited to receiving, by a computing device, data from a source. How the data maps to a target that is remote from the source may be defined. At least a portion of the data for change events may be monitored. At least the portion of the data for the change events may be scanned to identify sensitive elements. On-the-fly tokenization of at least the portion of the data for the change events identified as the sensitive elements may be provided. A replication key for the on-the-fly tokenization may be compared against a last stored value. At least the portion of the data may be eliminated when the replication key matches the last stored value. At least the portion of the data may be stored at the target when the replication key is different than the last stored value.

One or more of the following example features may be included. The change events may be batch processed into configurable chunks. The configurable chunks may be configurable by at least one of row batches and intervals. The batch processing may pause reads if a next stage is busy. The batch processing may replay failed batches using an exactly-once token. The batch processing may maintain event ordering per partition. Monitoring at least the portion of the data for change events may include generating a subscription for the change events. Monitoring at least the portion of the data for the change events may include creating a change-stream definition to identify at least the portion of the data to monitor for changes. Scanning at least the portion of the data for the change events to identify the sensitive elements may include flagging the sensitive elements using machine learning based classifiers to detect sensitive fields. Scanning at least the portion of the data for the change events to identify the sensitive elements may include flagging the sensitive elements using pattern recognition for known ID formats to detect sensitive fields. Scanning at least the portion of the data for the change events to identify the sensitive elements may include flagging the sensitive elements using context-aware classifiers to detect sensitive fields. Providing on-the-fly tokenization of at least the portion of the data for the change events identified as the sensitive elements may include triggering a tokenization application programming interface (API) in real-time. Providing on-the-fly tokenization of at least the portion of the data for the change events identified as the sensitive elements may include selecting a format-preserving encryption. Providing on-the-fly tokenization of at least the portion of the data for the change events identified as the sensitive elements may include selecting a random surrogate token stored in a vault. Providing on-the-fly tokenization of at least the portion of the data for the change events identified as the sensitive elements may include eliminating persistent cleartext copies. Comparing a replication key for the on-the-fly tokenization against the last stored value may include hashing a minimal set of business keys and change-timestamps. Storing at least the portion of the data at the target when the replication key is different than the last stored value may include issuing an insert into a live table for at least the portion of the data at the target. Storing at least the portion of the data at the target when the replication key is different than the last stored value may include issuing an update into a live table for at least the portion of the data at the target.

The details of one or more example implementations are set forth in the accompanying drawings and the description below. Other possible example features and/or possible example advantages will become apparent from the description, the drawings, and the claims. Some implementations may not have those possible example features and/or possible example advantages, and such possible example features and/or possible example advantages may not necessarily be required of some implementations.

### DRAWINGS

FIG. 1 is an example diagrammatic view of a data replication process coupled to an example distributed computing network according to one or more example implementations of the disclosure;

FIG. 2 is an example diagrammatic view of a storage system of FIG. 1 according to one or more example implementations of the disclosure;

FIG. 3 is an example diagrammatic view of a storage target of FIG. 1 according to one or more example implementations of the disclosure;

FIG. 4 is an example flowchart of a data replication process according to one or more example implementations of the disclosure;

FIG. 5 is an example diagrammatic view of an alternative view of an architecture of FIG. 1 according to one or more example implementations of the disclosure;

FIG. 6 is an example alternative view of a flowchart of a data replication process according to one or more example implementations of the disclosure; and FIG. 7 is an example alternative view of a flowchart of a data replication process according to one or more example implementations of the disclosure.

Like reference symbols in the various drawings indicate like elements.

### DESCRIPTION

### System Overview:

As noted above, modern enterprises frequently maintain critical business data in on-premises data stores (e.g., relational database management systems (RDBMS) and similar platforms). To support analytics, reporting, and cross-enterprise data sharing, it has become common practice to replicate- or “ship”-changes from these operational systems into cloud data warehouses. Traditional replication approaches rely on Extract-Transform-Load (ETL) pipelines that periodically bulk-export full table snapshots or deltas, persist them to intermediate storage, then re-load them into the target. While admittedly robust, these batch-oriented methods introduce significant latency (often measured in hours or days), consume large amounts of intermediate disk space, and require extensive custom scripting to handle schema drift, type conversions, and failure recovery.

To reduce latency, Change-Data-Capture (CDC) solutions have been developed that read database transaction logs or leverage built-in CDC APIs to stream individual events (e.g., inserts, updates, deletes) as they occur. Commercial offerings support near-real-time propagation of change events into downstream systems, and can be paired with streaming platforms or cloud-native event buses. However, these CDC tools typically focus solely on data movement and offer limited facilities for automated schema mapping, runtime subscription management, or integrated data-quality checks. Moreover, when the replication target is a modern cloud data warehouse, the high degree of parallelism inherent to CDC can overwhelm the target's concurrency controls, leading to throttling or failures.

Separately, data-loss-prevention frameworks and tokenization products have emerged to scan and protect high-risk sensitive data elements (HRSDE) such as personally identifiable information (PII) or protected health information (PHI). These systems are generally employed in stand-alone fashion-extracting data into a secure vault, performing offline tokenization or format-preserving encryption, then writing the de-identified outputs back to a staging area. This multi-stage approach usually incurs additional I/O overhead, increases attack surface by creating copy-at-rest artifacts, and complicates end-to-end data lineage. Likewise, most replication and tokenization solutions do not natively produce history tables (e.g., Slowly Changing Dimension Type 2 (SCD 2) history tables) and organizations must build separate ETL jobs to capture historical versions, thereby incurring further development and maintenance costs.

Therefore, as will be discussed in greater detail below, the present disclosure describes an integrated, end-to-end platform that unifies one or more aspects, such as real-time change-data-capture, automated schema and subscription management, on-the-fly sensitive-data tokenization, target-view orchestration, built-in data-integrity validation, and SCD 2 change-history tracking-while respecting the concurrency constraints and operational limits of both on-premises sources and cloud-native targets. Such a platform would eliminate redundant data copies, reduce latency and operational complexity, and provide a single, cohesive solution for secure, scalable, and auditable data replication without risking exposure to sensitive information.

In some implementations, the present disclosure may be embodied as a method, system, or computer program product. Accordingly, in some implementations, the present disclosure may take the form of an entirely hardware implementation, an entirely software implementation (including firmware, resident software, micro-code, etc.) or an implementation combining software and hardware aspects that may all generally be referred to herein as a “circuit,” “module” or “system.” Furthermore, in some implementations, the present disclosure may take the form of a computer program product on a computer-usable storage medium having computer-usable program code embodied in the medium.

Software may include artificial intelligence (AI) systems, which may include machine learning or other computational intelligence. For example, AI may include one or more models used for one or more problem domains. When presented with many data features, identification of a subset of features that are relevant to a problem domain may improve prediction accuracy, reduce storage space, and increase processing speed. This identification may be referred to as feature engineering. Feature engineering may be performed by users or may only be guided by users. In various implementations, a machine learning system may computationally identify relevant features, such as by performing singular value decomposition on the contributions of different features to outputs.

In some implementations, the various computing devices may include, integrate with, link to, exchange data with, be governed by, take inputs from, and/or provide outputs to one or more AI systems, which may include models, rule-based systems, expert systems, neural networks, deep learning systems, supervised learning systems, robotic process automation systems, natural language processing systems, intelligent agent systems, self-optimizing and self-organizing systems, and others. Except where context specifically indicates otherwise, references to AI, or to one or more examples of AI, should be understood to encompass one or more of these various alternative methods and systems; for example, without limitation, an AI system described for enabling any of a wide variety of functions, capabilities and solutions described herein (such as optimization, autonomous operation, prediction, control, orchestration, or the like) should be understood to be capable of implementation by operation on a model or rule set; by training on a training data set of human tag, labels, or the like; by training on a training data set of human interactions (e.g., human interactions with software interfaces or hardware systems); by training on a training data set of outcomes; by training on an AI-generated training data set (e.g., where a full training data set is generated by AI from a seed training data set); by supervised learning; by semi-supervised learning; by deep learning; or the like. For any given function or capability that is described herein, neural networks of various types may be used, including any of the types described herein, and in embodiments a hybrid set of neural networks may be selected such that within the set a neural network type that is more favorable for performing each element of a multi-function or multi-capability system or method is implemented. As one example among many, a deep learning, or black box, system may use a gated recurrent neural network for a function like language translation for an intelligent agent, where the underlying mechanisms of AI operation need not be understood as long as outcomes are favorably perceived by users, while a more transparent model or system and a simpler neural network may be used for a system for automated governance, where a greater understanding of how inputs are translated to outputs may be needed to comply with regulations or policies.

Examples of the models (e.g., AI-based models) include recurrent neural networks (RNNs) such as long short-term memory (LSTM), deep learning models such as transformers, decision trees, support-vector machines, genetic algorithms, Bayesian networks, and regression analysis. Examples of systems based on a transformer model include bidirectional encoder representations from transformers (BERT) and generative pre-trained transformers (GPT). Training a machine-learning model (or other type of AI-based learning models) may include supervised learning (for example, based on labelled input data), unsupervised learning, and reinforcement learning. In various embodiments, a machine-learning model may be pre-trained by their operator or by a third party. Problem domains include nearly any situation where structured data can be collected, and includes natural language processing (NLP), including natural language understanding (NLU), computer vision (CV), classification, image recognition, etc. Some or all of the software may run in a virtual environment rather than directly on hardware. The virtual environment may include a hypervisor, emulator, sandbox, container engine, etc. The software may be built as a virtual machine, a container, etc. Virtualized resources may be controlled using, for example, a DOCKER container platform, a pivotal cloud foundry (PCF) platform, etc. Some or all of the software may be logically partitioned into microservices. Each microservice offers a reduced subset of functionality. In various embodiments, each microservice may be scaled independently depending on load, either by devoting more resources to the microservice or by instantiating more instances of the microservice. In various embodiments, functionality offered by one or more microservices may be combined with each other and/or with other software not adhering to a microservices model.

In some implementations, as noted above, AI-based learning models may include at least one of a transformer model, a convolutional neural network, a deep learning model trained on a set of outcomes of the value chain network entity, a supervised model, a semi-supervised model, an unsupervised model, or a reinforcement model, and the training data set for the AI-based learning models may include one or a set of objects or events that are labeled to classify the set of objects or events according to a classification taxonomy. Other examples of AI-based learning models (e.g., machine learning models) may include neural networks in general (e.g., deep neural networks, convolution neural networks, and many others), regression-based models, decision trees, hidden forests, Hidden Markov models, Bayesian models, and the like. In some implementations, the present disclosure may include combinations where an expert system uses one neural network for classifying an item and a different (or the same) neural network for predicting a state of the item.

In some implementations, any suitable computer usable or computer readable medium (or media) may be utilized. The computer readable medium may be a computer readable signal medium or a computer readable storage medium. The computer-usable, or computer-readable, storage medium (including a storage device associated with a computing device or client electronic device) may be, for example, but is not limited to, an electronic, magnetic, optical, electromagnetic, infrared, or semiconductor system, apparatus, device, or any suitable combination of the foregoing. More specific examples (a non-exhaustive list) of the computer-readable medium or storage device may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, solid state drives (SSDs), a digital versatile disk (DVD), a Blu-ray disc, and an Ultra HD Blu-ray disc, a static random access memory (SRAM), dynamic RAM (DRAM), synchronous DRAM (SDRAM), synchronous graphics RAM (SGRAM), and video RAM (VRAM), analog magnetic tape, digital magnetic tape, rotating hard disk drive (HDDs), a memory stick, a floppy disk, a mechanically encoded device such as punch-cards or raised structures in a groove having instructions recorded thereon, a media such as those supporting the internet or an intranet, or a magnetic storage device. Note that the computer-usable or computer-readable medium could even be a suitable medium upon which the program is stored, scanned, compiled, interpreted, or otherwise processed in a suitable manner, if necessary, and then stored in a computer memory. In the context of the present disclosure, a computer-usable or computer-readable, storage medium may be any tangible medium that can contain or store a program for use by or in connection with the instruction execution system, apparatus, or device.

Examples of storage implemented by the storage hardware include a distributed ledger, such as a permissioned or permissionless blockchain. Entities recording transactions, such as in a blockchain, may reach consensus using an algorithm such as proof-of-stake, proof-of-work, and proof-of-storage. Elements of the present disclosure may be represented by or encoded as non-fungible tokens (NFTs). Ownership rights related to the non-fungible tokens may be recorded in or referenced by a distributed ledger. Transactions initiated by or relevant to the present disclosure may use one or both of fiat currency and cryptocurrencies, examples of which include bitcoin and ether.

In some implementations, a computer readable signal medium may include a propagated data signal with computer readable program code embodied therein, for example, in baseband or as part of a carrier wave. In some implementations, such a propagated signal may take any of a variety of forms, including, but not limited to, electromagnetic, optical, or any suitable combination thereof. In some implementations, the computer readable program code may be transmitted using any appropriate medium, including but not limited to the internet, wireline, optical fiber cable, RF, etc. In some implementations, a computer readable signal medium may be any computer readable medium that is not a computer readable storage medium and that can communicate, propagate, or transport a program for use by or in connection with an instruction execution system, apparatus, or device.

In some implementations, computer program code for carrying out operations of the present disclosure may be assembler instructions, instruction-set-architecture (ISA) instructions, machine instructions, machine dependent instructions, microcode, firmware instructions, state-setting data, state information that personalizes electronic circuitry and/or other structural components that are native to hardware (e.g., host processor, central processing unit/CPU, microcontroller, etc.) or either source code or object code written in any combination of one or more programming languages, including an object oriented programming language such as Java®, Smalltalk, C++ or the like. Java® and all Java-based trademarks and logos are trademarks or registered trademarks of Oracle and/or its affiliates. However, the computer program code for carrying out operations of the present disclosure may also be written in conventional procedural programming languages, such as the “C” programming language, PASCAL, or similar programming languages, as well as in scripting languages such as JavaScript, PERL, or Python. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a network, such as a cellular network, local area network (LAN), a wide area network (WAN), a body area network BAN), a personal area network (PAN), a metropolitan area network (MAN), etc., or the connection may be made to an external computer (for example, through the internet using an Internet Service Provider). The networks may include one or more of point-to-point and mesh technologies. Data transmitted or received by the networking components may traverse the same or different networks. Networks may be connected to each other over a WAN or point-to-point leased lines using technologies such as Multiprotocol Label Switching (MPLS) and virtual private networks (VPNs), etc. In some implementations, electronic circuitry including, for example, programmable logic circuitry, an application specific integrated circuit (ASIC), gate arrays such as field-programmable gate arrays (FPGAs) or other hardware accelerators, microcontroller units (MCUs), or programmable logic arrays (PLAs), integrated circuits (ICs), digital circuit elements, analog circuit elements, combinational logic circuits, digital signal processors (DSPs), complex programmable logic devices (CPLDs), memory chips, network chips, systems on chip (SoCs), SSD/NAND controller ASICs, and the like, etc. may execute the computer readable program instructions/code by utilizing state information of the computer readable program instructions to personalize the electronic circuitry, in order to perform aspects of the present disclosure. Configurable or fixed-functionality logic may be implemented with complementary metal oxide semiconductor (CMOS) logic circuits, transistor-transistor logic (TTL) logic circuits, or other circuits. Multiple components of the hardware may be integrated, such as on a single die, in a single package, or on a single printed circuit board or logic board. For example, multiple components of the hardware may be implemented as a system-on-chip. A component, or a set of integrated components, may be referred to as a chip, chipset, chiplet, or chip stack. Examples of a system-on-chip include a radio frequency (RF) system-on-chip, an AI system-on-chip, a video processing system-on-chip, an organ-on-chip, a quantum algorithm system-on-chip, etc.

Examples of processing hardware may include, e.g., a central processing unit (CPU), a graphics processing unit (GPU), an accelerator (e.g., an AI accelerator), an approximate computing processor, a quantum computing processor, a parallel computing processor, a neural network processor, a signal processor, a digital processor, an analog processor, a data processor, an embedded processor, a microprocessor, and a co-processor. The co-processor may provide additional processing functions and/or optimizations, such as for speed or power consumption. Examples of a co-processor include a math co-processor, a graphics co-processor, a communication co-processor, a video co-processor, and an AI co-processor.

In some implementations, the AI accelerator may include suitable logic, circuitry, and/or interfaces to accelerate artificial intelligence applications, such as, e.g., artificial neural networks, machine vision and machine learning applications, including through parallel processing techniques. In one or more examples, the AI accelerator may include hardware logic or devices such as, e.g., a GPU or an FPGA. The AI accelerator may be used with any of the devices, components, features or methods described herein.

In some implementations, the flowchart and block diagrams in the figures illustrate the architecture, functionality, and operation of possible implementations of apparatus (systems), methods and computer program products according to various implementations of the present disclosure. Each block in the flowchart and/or block diagrams, and combinations of blocks in the flowchart and/or block diagrams, may represent a module, segment, or portion of code, which comprises one or more executable computer program instructions for implementing the specified logical function(s)/act(s). These computer program instructions may be provided to a processor of a general purpose computer, special purpose computer, or other programmable data processing apparatus to produce a machine, such that the computer program instructions, which may execute via the processor of the computer or other programmable data processing apparatus, create the ability to implement one or more of the functions/acts specified in the flowchart and/or block diagram block or blocks or combinations thereof. It should be noted that, in some implementations, the functions noted in the block(s) may occur out of the order noted in the figures (or combined or omitted). For example, two blocks shown in succession may, in fact, be executed substantially concurrently, or the blocks may sometimes be executed in the reverse order, depending upon the functionality involved. In addition, in some of the drawings, signal conductor lines may be represented with lines. Some may be different, to indicate more constituent signal paths, have a number label, to indicate a number of constituent signal paths, and/or have arrows at one or more ends, to indicate primary information flow direction(s). This, however, should not be construed in a limiting manner. Rather, such added detail may be used in connection with one or more implementations to facilitate ease of understanding. Any represented lines, whether or not having additional information, may actually comprise one or more signals/information that may travel in multiple directions and may be implemented with any suitable type of signal scheme, e.g., digital or analog lines implemented with differential pairs, optical fiber lines, and/or single-ended lines, etc.

In some implementations, these computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks or combinations thereof.

In some implementations, the computer program instructions may also be loaded onto a computer or other programmable data processing apparatus to cause a series of operational steps to be performed (not necessarily in a particular order) on the computer or other programmable apparatus to produce a computer implemented process such that the instructions which execute on the computer or other programmable apparatus provide steps for implementing the functions/acts (not necessarily in a particular order) specified in the flowchart and/or block diagram block or blocks or combinations thereof.

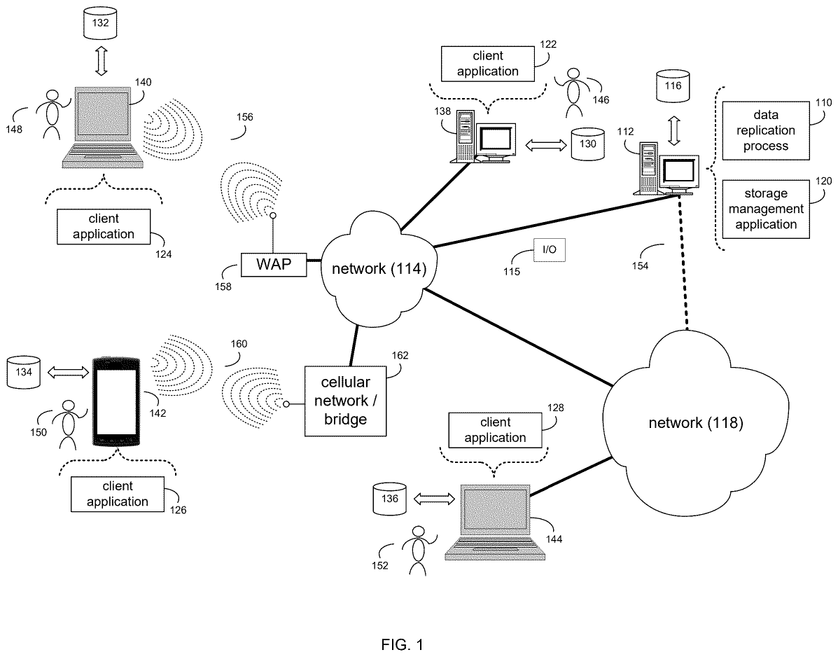

Referring now to the example implementation of FIG. 1, there is shown data replication process 110 that may reside on and may be executed by a computer (e.g., computer 112), which may be connected to a network (e.g., network 114) (e.g., the internet or a local area network). Examples of computer 112 (and/or one or more of the client electronic devices noted below) may include, but are not limited to, a storage system (e.g., a Network Attached Storage (NAS) system, a Storage Area Network (SAN)), a personal computer(s), a laptop computer(s), mobile computing device(s), a server computer, a series of server computers, a mainframe computer(s), or a computing cloud(s). A SAN may include one or more of the client electronic devices, including a RAID device and a NAS system. In some implementations, each of the aforementioned may be generally described as a computing device. In certain implementations, a computing device may be a physical or virtual device. In many implementations, a computing device may be any device capable of performing operations, such as a dedicated processor, a portion of a processor, a virtual processor, a portion of a virtual processor, portion of a virtual device, or a virtual device. In some implementations, a processor may be a physical processor or a virtual processor. In some implementations, a virtual processor may correspond to one or more parts of one or more physical processors. In some implementations, the instructions/logic may be distributed and executed across one or more processors, virtual or physical, to execute the instructions/logic. Computer 112 may execute an operating system, for example, but not limited to, Microsoft® Windows®; Mac® OS X®; Red Hat® Linux®, Windows® Mobile, Chrome OS, Blackberry OS, Fire OS, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

In some implementations, as will be discussed below in greater detail, a data replication process, such as data replication process 110 of FIG. 1, may receive, by a computing device, data from a source. How the data maps to a target that is remote from the source may be defined. At least a portion of the data for change events may be monitored. At least the portion of the data for the change events may be scanned to identify sensitive elements. On-the-fly tokenization of at least the portion of the data for the change events identified as the sensitive elements may be provided. A replication key for the on-the-fly tokenization may be compared against a last stored value. At least the portion of the data may be eliminated when the replication key matches the last stored value. At least the portion of the data may be stored at the target when the replication key is different than the last stored value.

In some implementations, the instruction sets and subroutines of data replication process 110, which may be stored on storage device, such as storage device 116, coupled to computer 112, may be executed by one or more processors and one or more memory architectures included within computer 112. In some implementations, storage device 116 may include but is not limited to: a hard disk drive; all forms of flash memory storage devices; a tape drive; an optical drive; a RAID array (or other array); a random access memory (RAM); a read-only memory (ROM); or combination thereof. In some implementations, storage device 116 may be organized as an extent, an extent pool, a RAID extent (e.g., an example 4D+1P R 5 , where the RAID extent may include, e.g., five storage device extents that may be allocated from, e.g., five different storage devices), a mapped RAID (e.g., a collection of RAID extents), or combination thereof.

In some implementations, network 114 may be connected to one or more secondary networks (e.g., network 118), examples of which may include but are not limited to: a local area network; a wide area network or other telecommunications network facility; or an intranet, for example. The phrase “telecommunications network facility,” as used herein, may refer to a facility configured to transmit, and/or receive transmissions to/from one or more mobile client electronic devices (e.g., cellphones, etc.) as well as many others.

In some implementations, computer 112 may include a data store, such as a database (e.g., relational database, object-oriented database, triplestore database, etc.), a data store, a data lake, a column store, and/or a data warehouse, and may be located within any suitable memory location, such as storage device 116 coupled to computer 112. In some implementations, data, metadata, information, etc. described throughout the present disclosure may be stored in the data store. In some implementations, computer 112 may utilize any known database management system such as, but not limited to, DB2, in order to provide multi-user access to one or more databases, such as the above noted relational database. In some implementations, the data store may also be a custom database, such as, for example, a flat file database or an XML database. In some implementations, any other form(s) of a data storage structure and/or organization may also be used. In some implementations, data replication process 110 may be a component of the data store, a standalone application that interfaces with the above noted data store and/or an applet/application that is accessed via client applications 122, 124, 126, 128. In some implementations, the above noted data store may be, in whole or in part, distributed in a cloud computing topology. In this way, computer 112 and storage device 116 may refer to multiple devices, which may also be distributed throughout the network.

In some implementations, computer 112 may execute a storage management application (e.g., storage management application 120 a storage system application, a cloud computing application, a data synchronization application, a data migration application, a garbage collection application, or other application that allows for the implementation and/or management of data in a clustered (or non-clustered) environment (or the like). [In some implementations, data replication process 110 and/or storage management application 120 may be accessed via one or more of client applications 122, 124, 126, 128. In some implementations, data replication process 110 may be a standalone application, or may be an applet/application/script/extension that may interact with and/or be executed within storage management application 120, a component of storage management application 120, and/or one or more of client applications 122, 124, 126, 128. In some implementations, storage management application 120 may be a standalone application, or may be an applet/application/script/extension that may interact with and/or be executed within data replication process 110, a component of data replication process 110, and/or one or more of client applications 122, 124, 126, 128. In some implementations, one or more of client applications 122, 124, 126, 128 may be a standalone application, or may be an applet/application/script/extension that may interact with and/or be executed within and/or be a component of data replication process 110 and/or storage management application 120. Examples of client applications 122, 124, 126, 128 may include, but are not limited to, e.g., a storage system application, a cloud computing application, a data synchronization application, a data migration application, a garbage collection application, or other application that allows for the implementation and/or management of data in a clustered (or non-clustered) environment (or the like), a chatbot application, a virtual assistant application, a standard and/or mobile web browser, an email application (e.g., an email client application), a textual and/or a graphical user interface, a customized web browser, a plugin, an Application Programming Interface (API), or a custom application. The instruction sets and subroutines of client applications 122, 124, 126, 128, which may be stored on storage devices 130, 132, 134, 136, may be executed by one or more processors and one or more memory architectures incorporated into client electronic devices 138, 140, 142, 144.

In some implementations, one or more of storage devices 130, 132, 134, 136, may include but are not limited to: hard disk drives; flash drives, tape drives; optical drives; RAID arrays; random access memories (RAM); and read-only memories (ROM). Examples of client electronic devices 138, 140, 142, 144 (and/or computer 112) may include, but are not limited to, a personal computer (e.g., client electronic device 138), a laptop computer (e.g., client electronic device 140), a smart/data-enabled, cellular phone (e.g., client electronic device 142), a notebook computer (e.g., client electronic device 144), a tablet, a server, a television, a smart television, a smart speaker, an Internet of Things (IoT) device, a media (e.g., audio/video, photo, etc.) capturing and/or output device, an audio input and/or recording device (e.g., a handheld microphone, a lapel microphone, an embedded microphone/speaker (such as those embedded within eyeglasses, smart phones, tablet computers, smart televisions, smart speakers, watches, etc.), an infotainment device (e.g., such as those found in vehicles combining information and/or entertainment with optional screens and/or audio for such things as navigation, multimedia, connectivity, voice control, smartphone integration, touchscreen interface, internet and apps, rear-seat entertainment, etc.), a dedicated network device, and combinations thereof. Client electronic devices 138, 140, 142, 144 may each execute an operating system, examples of which may include but are not limited to, Android™, Apple® iOS®, Mac® OS X®; Red Hat® Linux®, Windows® Mobile, Chrome OS, Blackberry OS, Fire OS, or a custom operating system.

In some implementations, one or more of client applications 122, 124, 126, 128 may be configured to effectuate some or all of the functionality of data replication process 110 (and vice versa). Accordingly, in some implementations, data replication process 110 may be a purely server-side application, a purely client-side application, or a hybrid server-side/client-side application that is cooperatively executed by one or more of client applications 122, 124, 126, 128 and/or data replication process 110.

In some implementations, one or more of client applications 122, 124, 126, 128 may be configured to effectuate some or all of the functionality of storage management application 120 (and vice versa). Accordingly, in some implementations, storage management application 120 may be a purely server-side application, a purely client-side application, or a hybrid server-side/client-side application that is cooperatively executed by one or more of client applications 122, 124, 126, 128 and/or storage management application 120. As one or more of client applications 122, 124, 126, 128, data replication process 110, and storage management application 120, taken singly or in any combination, may effectuate some or all of the same functionality, any description of effectuating such functionality via one or more of client applications 122, 124, 126, 128, data replication process 110, storage management application 120, or combination thereof, and any described interaction(s) between one or more of client applications 122, 124, 126, 128, data replication process 110, storage management application 120, or combination thereof to effectuate such functionality, should be taken as an example only and not to limit the scope of the disclosure.

In some implementations, one or more of users 146, 148, 150, 152 may access computer 112 and data replication process 110 (e.g., using one or more of client electronic devices 138, 140, 142, 144) directly through network 114 or through network 118. Further, computer 112 may be connected to network 114 through network 118, as illustrated with phantom link line 154. Data replication process 110 may include one or more user interfaces, such as browsers and textual or graphical user interfaces, through which users 146, 148, 150, 152 may access data replication process 110.

In some implementations, the various client electronic devices may be directly or indirectly coupled to network 114 (or network 118). For example, client electronic device 138 is shown directly coupled to network 114 via a hardwired network connection. Further, client electronic device 144 is shown directly coupled to network 118 via a hardwired network connection. Client electronic device 140 is shown wirelessly coupled to network 114 via wireless communication channel 156 established between client electronic device 140 and wireless access point (i.e., WAP 158), which is shown directly coupled to network 114. WAP 158 may be, for example, an IEEE 802.11a, 802.11b, 802.11g, 802.11n, 802.11ac, Wi-Fi®, RFID, and/or Bluetooth™ (including Bluetooth™ Low Energy) or any device that is capable of establishing wireless communication channel 156 between client electronic device 140 and WAP 158 (e.g., Zigbee, Z-Wave, etc.). Client electronic device 142 is shown wirelessly coupled to network 114 via wireless communication channel 160 established between client electronic device 142 and cellular network/bridge 162, which is shown by example directly coupled to network 114.

In some implementations, some or all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. Bluetooth™ (including Bluetooth™ Low Energy) is a telecommunications industry specification that allows, e.g., mobile phones, computers, smart phones, and other electronic devices to be interconnected using a short-range wireless connection. Other forms of interconnection (e.g., Near Field Communication (NFC)) may also be used. In some implementations, computer 112 may be directed or controlled by an operator. Computer 112 may be hosted by one or more of assets owned by the operator, assets leased by the operator, and third-party assets. The assets may be referred to as a private, community, or hybrid cloud computing network or cloud computing environment. For example, computer 112 may be partially or fully hosted by a third-party offering software as a service (Saas), platform as a service (PaaS), and/or infrastructure as a service (IaaS). Computer 112 may be implemented using agile development and operations (DevOps) principles. In some implementations, some or all of computer 112 may be implemented in a multiple-environment architecture. For example, the multiple environments may include one or more production environments, one or more integration environments, one or more development environments, etc.

In some implementations, various I/O requests (e.g., I/O request 115) may be sent from, e.g., client applications 122, 124, 126, 128 to, e.g., computer 112 (and vice versa). Examples of I/O request 115 may include but are not limited to, data write requests (e.g., a request that content be written to computer 112) and data read requests (e.g., a request that content be read from computer 112). Client electronic devices 138, 140, 142, 144 and/or computer 112 may also communicate audibly using an audio codec, which may receive spoken information from a user and convert it to usable digital information. An audio codec may likewise generate audible sound for a user, such as through a speaker, e.g., in a handset of a client electronic device. Such sound may include sound from voice telephone calls, may include recorded sound (e.g., voice messages, music files, etc.) and may also include sound generated by applications operating on the client electronic devices.

### Data Storage System:

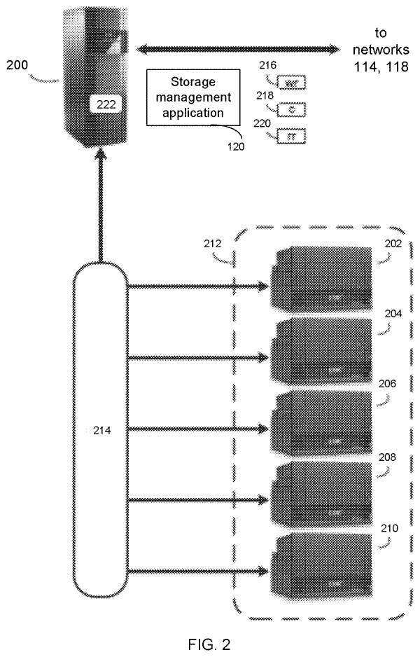

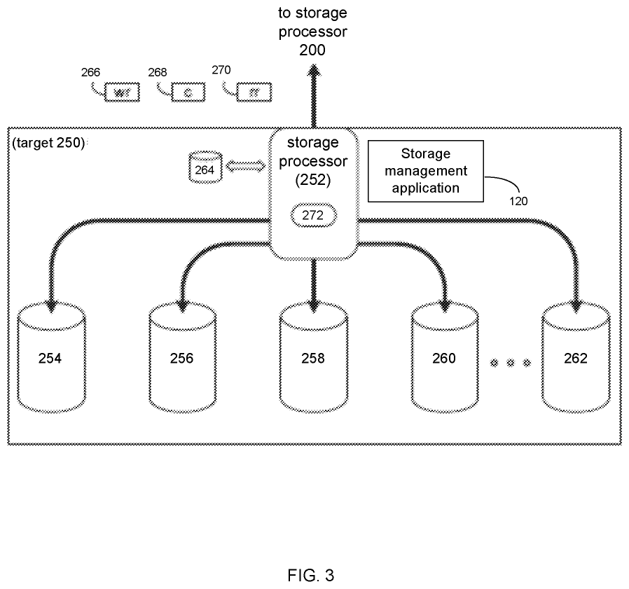

Referring also to the example implementation of FIGS. 2-3 (e.g., where computer 112 may be configured as a data storage system), computer 112 may include storage processor 200 and a plurality of storage targets (e.g., storage targets 202, 204, 206, 208, 210). In some implementations, storage targets 202, 204, 206, 208, 210 may include any of the above-noted storage devices. In some implementations, storage targets 202, 204, 206, 208, 210 may be configured to provide various levels of performance and/or high availability. For example, storage targets 202, 204, 206, 208, 210 may be configured to form a non-fully-duplicative fault-tolerant data storage system (such as a non-fully-duplicative RAID data storage system), examples of which may include but are not limited to: RAID 3 arrays, RAID 4 arrays, RAID 5 arrays, and/or RAID 6 arrays. It will be appreciated that various other types of RAID arrays may be used without departing from the scope of the present disclosure.

While in this particular example, computer 112 is shown to include five storage targets (e.g., storage targets 202, 204, 206, 208, 210), this is for example purposes only and is not intended limit the present disclosure. For instance, the actual number of storage targets may be increased or decreased depending upon, e.g., the level of redundancy/performance/capacity required.

Further, the storage targets (e.g., storage targets 202, 204, 206, 208, 210) included with computer 112 may be configured to form a plurality of discrete storage arrays. For instance, and assuming for example purposes only that computer 112 includes, e.g., ten discrete storage targets, a first five targets (of the ten storage targets) may be configured to form a first RAID array and a second five targets (of the ten storage targets) may be configured to form a second RAID array.

In some implementations, one or more of storage targets 202, 204, 206, 208, 210 may be configured to store coded data (e.g., via storage management application 120), wherein such coded data may allow for the regeneration of data lost/corrupted on one or more of storage targets 202, 204, 206, 208, 210. Examples of such coded data may include but is not limited to parity data and Reed-Solomon data. Such coded data may be distributed across all of storage targets 202, 204, 206, 208, 210 or may be stored within a specific storage target.

Examples of storage targets 202, 204, 206, 208, 210 may include one or more data arrays, wherein a combination of storage targets 202, 204, 206, 208, 210 (and any processing/control systems associated with storage management application 120) may form data array 212.

The manner in which computer 112 is implemented may vary depending upon e.g., the level of redundancy/performance/capacity required. For example, computer 112 may be configured as a SAN (i.e., a Storage Area Network), in which storage processor 200 may be, e.g., a dedicated computing system and each of storage targets 202, 204, 206, 208, 210 may be a RAID device. An example of storage processor 200 may include but is not limited to a VPLEX™, VNX™, TRIDENT™, or Unity™system offered by Dell EMC™ of Hopkinton, MA.

In the example where computer 112 is configured as a SAN, the various components of computer 112 (e.g., storage processor 200, and storage targets 202, 204, 206, 208, 210) may be coupled using network infrastructure 214, examples of which may include but are not limited to an Ethernet (e.g., Layer 2 or Layer 3) network, a fiber channel network, an InfiniBand network, or any other circuit switched/packet switched network.

As discussed above, various I/O requests (e.g., I/O request 15) may be generated. For example, these I/O requests may be sent from, e.g., client applications 122, 124, 126, 128 to, e.g., computer 112. Additionally/alternatively (e.g., when storage processor 200 is configured as an application server or otherwise), these I/O requests may be internally generated within storage processor 200 (e.g., via storage management application 120). Examples of I/O request 115 may include but are not limited to data write request 216 (e.g., a request that content 218 be written to computer 112) and data read request 220 (e.g., a request that content 218 be read from computer 112).

In some implementations, during operation of storage processor 200, content 218 to be written to computer 112 may be received and/or processed by storage processor 200 (e.g., via storage management application 120). Additionally/alternatively (e.g., when storage processor 200 is configured as an application server or otherwise), content 218 to be written to computer 112 may be internally generated by storage processor 200 (e.g., via storage management application 120).

As discussed above, the instruction sets and subroutines of storage management application 120, which may be stored on storage device 116 included within computer 112, may be executed by one or more processors and one or more memory architectures included with computer 112. Accordingly, in addition to being executed on storage processor 200, some or all of the instruction sets and subroutines of storage management application 120 (and/or data replication process 110) may be executed by one or more processors and one or more memory architectures included with data array 212.

In some implementations, storage processor 200 may include front end cache memory system 222. Examples of front end cache memory system 222 may include but are not limited to a volatile, solid-state, cache memory system (e.g., a dynamic RAM cache memory system), a non-volatile, solid-state, cache memory system (e.g., a flash-based, cache memory system), and/or any of the above-noted storage devices.

In some implementations, storage processor 200 may initially store content 218 within front end cache memory system 222. Depending upon the manner in which front end cache memory system 222 is configured, storage processor 200 (e.g., via storage management application 120) may immediately write content 218 to data array 212 (e.g., if front end cache memory system 222 is configured as a write-through cache) or may subsequently write content 218 to data array 212 (e.g., if front end cache memory system 222 is configured as a write-back cache).

In some implementations, one or more of storage targets 202, 204, 206, 208, 210 may include a backend cache memory system. Examples of the backend cache memory system may include but are not limited to a volatile, solid-state, cache memory system (e.g., a dynamic RAM cache memory system), a non-volatile, solid-state, cache memory system (e.g., a flash-based, cache memory system), and/or any of the above-noted storage devices.

### Storage Targets:

As discussed above, one or more of storage targets 202, 204, 206, 208, 210 may be a RAID device. For instance, and referring also to FIG. 3, there is shown example target 250, wherein target 250 may be one example implementation of a RAID implementation of, e.g., storage target 202, storage target 204, storage target 206, storage target 208, and/or storage target 210. An example of target 250 may include but is not limited to a VPLEX TM, VNX TM, TRIDENT TM, or Unity TM system offered by Dell EMC TM of Hopkinton, MA. Examples of storage devices 254, 256, 258, 260, 262 may include one or more electro-mechanical hard disk drives, one or more solid-state/flash devices, and/or any of the above-noted storage devices. It will be appreciated that while the term “disk” or “drive” may be used throughout, these may refer to and be used interchangeably with any types of appropriate storage devices as the context and functionality of the storage device permits.

In some implementations, target 250 may include storage processor 252 and a plurality of storage devices (e.g., storage devices 254, 256, 258, 260, 262). Storage devices 254, 256, 258, 260, 262 may be configured to provide various levels of performance and/or high availability (e.g., via storage management application 120). For example, one or more of storage devices 254, 256, 258, 260, 262 (or any of the above-noted storage devices) may be configured as a RAID 0 array, in which data is striped across storage devices. By striping data across a plurality of storage devices, improved performance may be realized. However, RAID 0 arrays may not provide a level of high availability. Accordingly, one or more of storage devices 254, 256, 258, 260, 262 (or any of the above-noted storage devices) may be configured as a RAID 1 array, in which data is mirrored between storage devices. By mirroring data between storage devices, a level of high availability may be achieved as multiple copies of the data may be stored within storage devices 254, 256, 258, 260, 262.

While storage devices 254, 256, 258, 260, 262 are discussed above as being configured in a RAID 0 or RAID 1 array, this is for example purposes only and not intended to limit the present disclosure, as other configurations are possible. For example, storage devices 254, 256, 258, 260, 262 may be configured as a RAID 3, RAID 4, RAID 5 or RAID 6 array.

While in this particular example, target 250 is shown to include five storage devices (e.g., storage devices 254, 256, 258, 260, 262), this is for example purposes only and not intended to limit the present disclosure. For instance, the actual number of storage devices may be increased or decreased depending upon, e.g., the level of redundancy/performance/capacity required.

In some implementations, one or more of storage devices 254, 256, 258, 260, 262 may be configured to store (e.g., via storage management application 120) coded data, wherein such coded data may allow for the regeneration of data lost/corrupted on one or more of storage devices 254, 256, 258, 260, 262. Examples of such coded data may include but are not limited to parity data and Reed-Solomon data. Such coded data may be distributed across all of storage devices 254, 256, 258, 260, 262 or may be stored within a specific storage device.

The manner in which target 250 is implemented may vary depending upon e.g., the level of redundancy/performance/capacity required. For example, target 250 may be a RAID device in which storage processor 252 is a RAID controller card and storage devices 254, 256, 258, 260, 262 are individual “hot-swappable” hard disk drives. Another example of target 250 may be a RAID system, examples of which may include but are not limited to an NAS (i.e., Network Attached Storage) device or a SAN (i.e., Storage Area Network).

In some implementations, storage target 250 may execute all or a portion of storage management application 120. The instruction sets and subroutines of storage management application 120, which may be stored on a storage device (e.g., storage device 264) coupled to storage processor 252, may be executed by one or more processors and one or more memory architectures included with storage processor 252. Storage device 264 may include but is not limited to any of the above-noted storage devices.

As discussed above, computer 112 may be configured as a SAN, wherein storage processor 200 may be a dedicated computing system and each of storage targets 202, 204, 206, 208, 210 may be a RAID device. Accordingly, when storage processor 200 processes data requests 216, 120, storage processor 200 (e.g., via storage management application 120) may provide the appropriate requests/content (e.g., write request 266, content 268 and read request 270) to, e.g., storage target 250 (which is representative of storage targets 202, 204, 206, 208 and/or 210).

In some implementations, during operation of storage processor 252, content 268 to be written to target 250 may be processed by storage processor 252 (e.g., via storage management application 120). Storage processor 252 may include cache memory system 272. Examples of cache memory system 272 may include but are not limited to a volatile, solid-state, cache memory system (e.g., a dynamic RAM cache memory system) and/or a non-volatile, solid-state, cache memory system (e.g., a flash-based, cache memory system). During operation of storage processor 252, content 268 to be written to target 250 may be received by storage processor 252 (e.g., via storage management application 120) and initially stored (e.g., via storage management application 120) within front end cache memory system 272.

### The Data Replication Process:

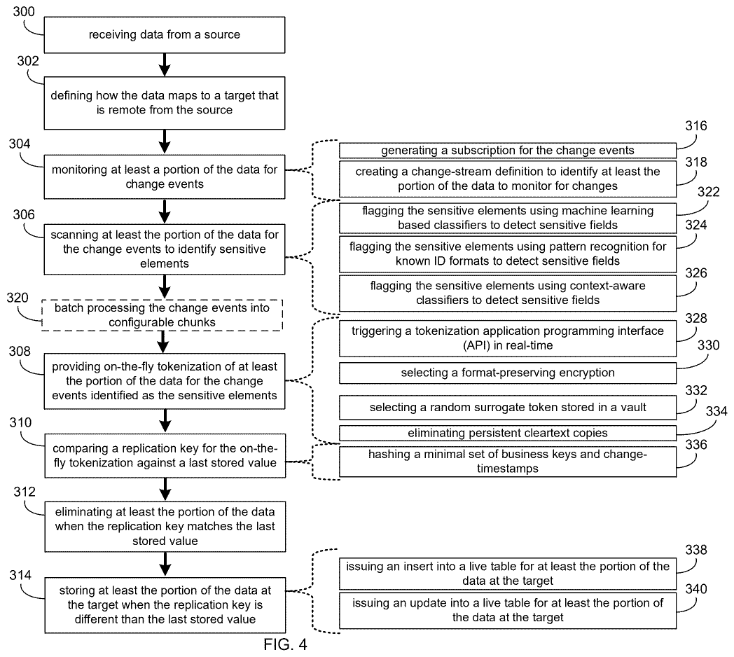

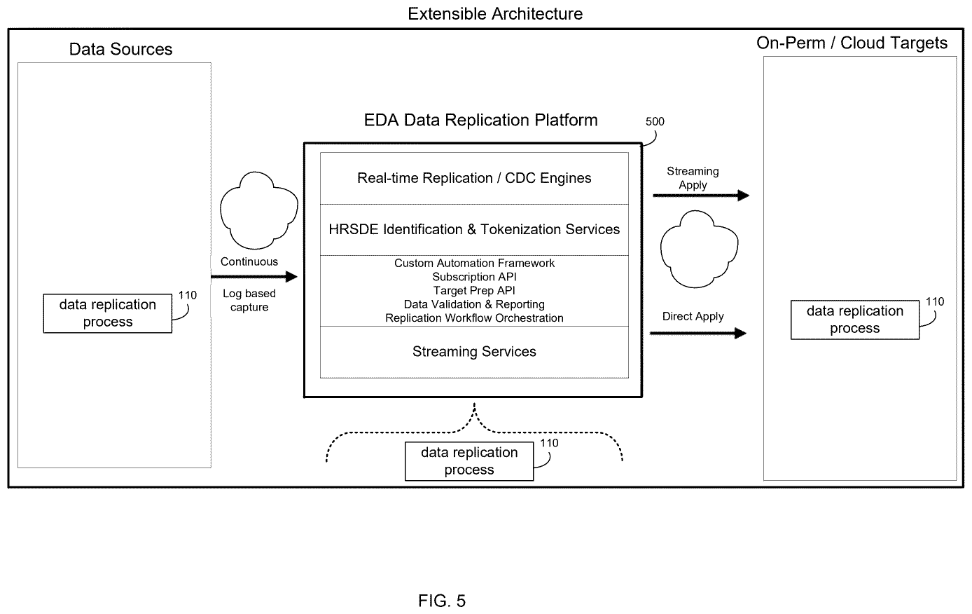

As discussed above and referring also at least to the example implementations of FIGS. 4-7, data replication process 110 may receive 300, by a computing device, data from a source. Data replication process 110 may define 302 how the data maps to a target that is remote from the source. Data replication process 110 may monitor 304 at least a portion of the data for change events. Data replication process 110 may scan 306 at least the portion of the data for the change events to identify sensitive elements. Data replication process 110 may provide 308 on-the-fly tokenization of at least the portion of the data for the change events identified as the sensitive elements. Data replication process 110 may compare 310 a replication key for the on-the-fly tokenization against a last stored value. Data replication process 110 may eliminate 312 at least the portion of the data when the replication key matches the last stored value. Data replication process 110 may store 314 at least the portion of the data at the target when the replication key is different than the last stored value.

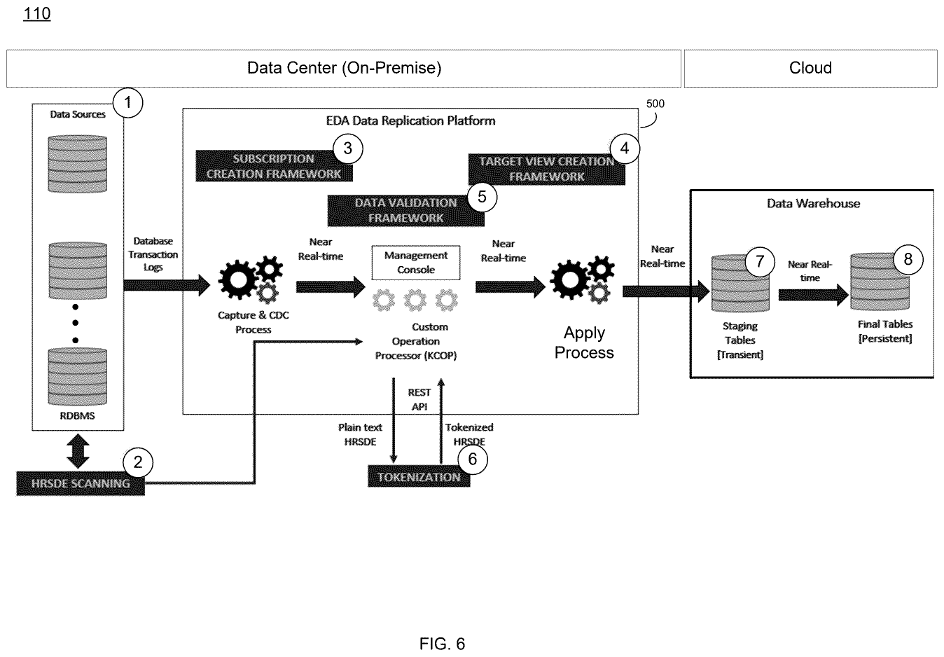

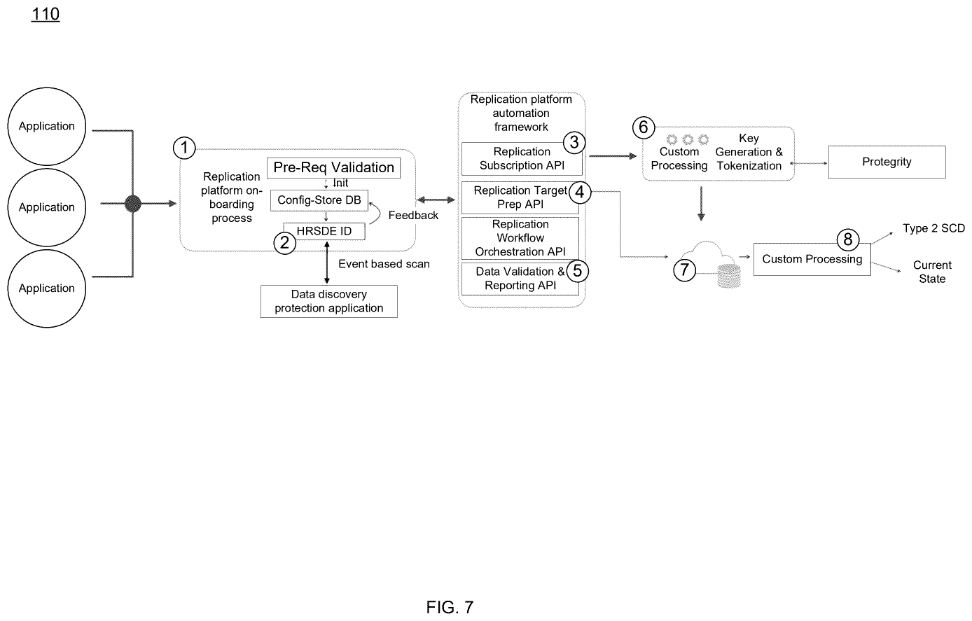

In some implementations, data replication process 110 may receive 300, by a computing device, data from a source, shown also as step 1 on FIGS. 6 and 7. For example, data replication process 110 may begin with a Change-Data-Capture (CDC) engine of data replication process 110 that attaches to each on-prem database's transaction log or native CDC tables. In one approach, the engine reads low-level redo/log files via a proprietary agent; in another, it calls the database's built-in CDC APIs to receive DML events (inserts, updates, deletes) as they occur. Whichever method is used, the CDC engine continuously streams each change event-complete with schema, commit timestamps, and transaction identifiers-to the next stage for processing. Generally speaking, the CDC engine may continuously monitors an operational database for data modifications (e.g., inserts, updates, and deletes) and streams those changes in near real time to downstream systems. Rather than relying on periodic, full-table extracts that can be slow and resource-intensive, a CDC engine taps directly into the database's native change-tracking mechanisms, such as its transaction log or a CDC API, to detect exactly which rows and columns have changed and when. Because it reads from the log rather than querying live tables, it imposes virtually no additional load on the production database and can deliver updates with latencies measured in seconds or even milliseconds.

In some implementations, the CDC engine comprises several tightly integrated modules. A log-reader component that intercepts or tails the database's low-level redo or write-ahead logs and hands raw change entries to a parser, which reconstructs each event into a semantic description (e.g., “row X in table T changed from A to B”) and enriches it with metadata like commit timestamps and transaction boundaries. These parsed events are then serialized, e.g., into JSON, Avro, or protobuf-and placed onto a streaming buffer or message bus. The buffering layer preserves event order on a per-table or per-partition basis, manages back-pressure if the target system falls behind, and enforces exactly-once or at-least-once delivery semantics as configured. Finally, connector adapters read from the stream and translate each change into the appropriate target operation (for example, SQL INSERT, UPDATE, or DELETE; REST API calls; or file writes), handling schema evolution automatically if the source database's structure changes over time.

By transforming the traditional Extract-Transform-Load (ETL) pattern into an event-driven pipeline, the CDC engine may deliver several advantageous example technical benefits, such as: low latency, because data is replicated almost immediately after it is committed; minimal impact on the source systems, since it avoids expensive table scans; transactional consistency, by applying all changes in the original commit order; and horizontal scalability, thanks to parallel log partitions and configurable worker threads. Together, these capabilities enable real-time analytics, reporting, and integration scenarios that would be impractical with conventional batch-oriented replication approaches.

In some implementations, data replication process 110 may define 302 how the data maps to a target that is remote from the source, shown also as step 2 on FIGS. 6 and 7. For example, when initializing a new replication pipeline, data replication process 110 of data replication platform 500 establishes a connection to each source database using its native driver (for example, JDBC). Data replication process 110 then performs a comprehensive metadata introspection pass: querying system catalogs or standard views such as INFORMATION_SCHEMA. TABLES and INFORMATION_SCHEMA. COLUMNS and invoking metadata APIs (like DatabaseMetaData. getTables, getColumns, getPrimaryKeys, and getImportedKeys) to retrieve every table name, column name, data type (including precision and scale), nullability, default expressions, primary-key definitions, and foreign-key relationships. Simultaneously, data replication process 110 48 consults database-specific type catalogs to resolve vendor-specific types, such as Oracle's NUMBER(p, s) or PostgreSQL's UUID, and builds an in-memory graph model of the entire source schema.

Once the in-memory model accurately reflects the source structure, data replication process 110 serializes it into a versioned mapping manifest (e.g., via JSON or YAML formatting), where each table entry specifies its source name, optional target rename, and an array of column entries with source and target type mappings, nullability rules, default-value overrides, and any user-defined transformation hints (such as date-format conversions or enumeration remappings). Users may refine this manifest either through, e.g., a GUI-driven wizard where tables and columns appear in a navigable tree with dropdowns for renaming and type conversion or by running a CLI script that auto-generates the manifest for manual editing. The finalized manifest then feeds directly into the subscription engine, which programmatically creates change-data subscriptions for the selected tables and columns, applies the declared transformations in its streaming pipeline, and automatically generates the DDL needed to materialize views or staging tables in the cloud target, eliminating the need for custom scripting or manual provisioning.

In some implementations, data replication process 110 may monitor 304 at least a portion of the data for change events, shown also as step 3 on FIGS. 6 and 7. For instance, in some implementations, monitoring at least the portion of the data for change events may include generating 316 a subscription for the change events, and creating 318 a change-stream definition to identify at least the portion of the data to monitor for changes. For example, when it is time to start streaming data, data replication process 110 takes the mapping manifest and, for each table, constructs a subscription definition that tells the CDC engine exactly which change events to capture and how to process them. In some implementations, this subscription creation is carried out via the CDC engine's management API (e.g., a REST or gRPC interface) where data replication process 110 issues a “CreateSubscription” call containing the fully qualified source table names, the specific columns to include (as determined by the manifest), and any filter predicates (for example, WHERE schema=‘HR’ or WHERE last_modified≥: watermark). The payload also declares delivery semantics (at-least-once vs. exactly-once), the desired batch size or time window for grouping change events, and the checkpointing strategy so the engine knows where to resume after an outage.

In some implementations, in addition to declaring which data to capture, the subscription request carries configuration for parallelism: the platform allocates a configurable number of worker threads or consumer partitions, often by hashing on a primary-key or composite key, so that multiple threads can read and process distinct slices of the transaction log in parallel. This partitioning ensures high throughput even when replicating billions of rows per hour. Because these subscriptions are managed through the CDC engine's API rather than hard-coded configuration files, data replication process 110 can scale dynamically by issuing an “UpdateSubscription” call to increase thread-pool count, adjust batch windows, or bind additional tables without ever shutting down the stream. New tables can be onboarded simply by submitting a delta update to the same subscription, and the CDC engine will begin tailing their logs immediately under the existing worker set, ensuring continuous, uninterrupted replication.

In some implementations, data replication process 110 may batch process 320 the change events into configurable chunks, shown also as step 4 on FIGS. 6 and 7. For instance, in some implementations, the configurable chunks may be configurable by at least one of row batches and intervals, the batch processing may pause reads if a next stage is busy, the batch processing may replay failed batches using an exactly-once token, and the batch processing may maintain event ordering per partition. For example, once the CDC subscriptions are active and change events are flowing in, data replication process 110 may group those raw events into small, manageable “mini-batches” before handing them off to downstream processors or sinks. There are two common but non-limiting triggers for forming a batch: a count threshold (e.g., every 1,000 rows) or a time window (e.g., every 1 second), whichever comes first. Internally, the stream processor of data replication process 110 may maintain a small buffer for each partition: as events arrive it appends them to the current batch, and once the batch is “full” by count or age, it atomically seals it and pushes it downstream.

Because downstream systems of data replication process 110 (e.g., tokenizers, vaults, cloud load services, etc.) can occasionally be slower than the inflow, data replication process 110 may implement back-pressure. Rather than consuming from the CDC engine's log reader at full tilt, data replication process 110 may monitor the size of its own outbound queue or the health of the downstream acknowledgements. If the queue grows beyond a high-water mark, it signals the CDC reader to pause, often by pausing the underlying socket or pausing the poll loop in a consumer so that no new events are read until the backlog drains below a low-water mark. This prevents unbounded memory growth and keeps the whole pipeline stable under load spikes.

To guarantee exactly-once delivery of each mini-batch, data replication process 110 may tag every batch with a unique, monotonically increasing token, derived from the CDC engine's own log offset or a combination of (partition, batch-sequence) identifiers. When a batch is successfully processed and acknowledged by the downstream sink, data replication process 110 commits that token as its checkpoint. If processing fails, data replication process 110 can rewind to the last committed token and replay any subsequent batches, ensuring no data is skipped or duplicated. In some implementations, this is akin to committing consumer offsets only after the external write succeeds, then seeking back on failure.

In some implementations, event ordering is preserved on a per-partition basis by ensuring that each partition's batches are processed sequentially. The stream processor locks a partition when it begins processing its next batch, and only after successful acknowledgment does it move on. Parallelism is achieved by assigning different partitions to different worker threads or nodes, but within each partition the original commit order is strictly maintained.

In some implementations, this “mini-batching & back-pressure layer” may be generated using frameworks where the Source Connector polls the CDC engine and the Connect framework handles batching, retries, and offset commits. Alternatively, a custom dispatcher may be generated using in-memory queues (e.g., Disruptor, BlockingQueue) and a small reactive library to more tightly control batching thresholds and bespoke acknowledgement logic. In either case, the core components are: buffered mini-batches, pause/resume control on upstream reads, idempotent batch tokens for replay, and per-partition ordering guarantees.

In some implementations, data replication process 110 may scan 306 at least the portion of the data for the change events to identify sensitive elements, shown also as step 5 on FIGS. 6 and 7. For instance, in some implementations, scanning at least the portion of the data for the change events to identify the sensitive elements may include flagging 322 the sensitive elements using machine learning based classifiers to detect sensitive fields, flagging 324 the sensitive elements using pattern recognition for known ID formats to detect sensitive fields, and flagging 326 the sensitive elements using context-aware classifiers to detect sensitive fields. For instance, before any data leaves the on-premises environment, each change-event record is handed off to a dedicated scanning framework of data replication process 110 that inspects every field for sensitive content. This framework may sit inline within the replication pipeline immediately after the mini-batching layer and exposes a high-throughput API that accepts a batch of records, applies a set of detection rules, and returns metadata tags indicating which columns are deemed high-risk. To avoid becoming a performance bottleneck, the scanner of data replication process 110 may be deployed as a horizontally scalable microservice cluster, maintaining an in-memory cache of recently seen values and compiled detection patterns, and it processes records asynchronously, returning tags in sub-millisecond time per row under typical loads.

In some implementations, the scanner of data replication process 110 may invoke third-party libraries such as PKWARE's Data Security Suite or Protegrity's Tokenization Framework. These tools provide two complementary detection engines: (1) a regex-based rule set for well-known formats (e.g., Social Security numbers, credit-card numbers, email addresses), and (2) a machine-learning classifier trained on labeled examples of PII/PHI, which leverages statistical features (character n-grams, token sequences) or contextual embeddings to catch free-form text like driver's-license IDs or health-insurance numbers. For environments that require more control, data replication process 110 may access custom pattern libraries where regular expressions are supplied for internal ID schemes or for use with training AI models (e.g., a conditional random field or a fine-tuned transformer) on proprietary data vocabulary. In each case, the scanner returns precise column-level flags that downstream tokenization logic uses to redact or encrypt only the fields marked as sensitive, ensuring no cleartext PII ever traverses beyond the data center.

In some implementations, data replication process 110 may provide 308 on-the-fly tokenization of at least the portion of the data for the change events identified as the sensitive elements, shown also as step 6 on FIGS. 6 and 7. For instance, in some implementations, providing on-the-fly tokenization of at least the portion of the data for the change events identified as the sensitive elements may include triggering 328 a tokenization application programming interface (API) in real-time, selecting 330 a format-preserving encryption, selecting 332 a random surrogate token stored in a vault, and eliminating 334 persistent cleartext copies. For example, when a record's schema indicates a field is sensitive, data replication process 110 may immediately invoke the tokenization service in-line with no batching or delayed jobs. For instance, a Java integration library may maintain a pool of secure, TLS-encrypted connections to an external tokenization endpoint (for example, Protegrity or a vault API). For each flagged value, data replication process 110 constructs a minimal JSON or binary RPC payload containing only the raw field and its context (e.g., table name, column name, correlation ID) and sends it to the token service of data replication process 110. Depending on the configuration, the service either applies a format-preserving encryption algorithm (such as NIST-approved FF1/FF3) so that the output matches the input's length, character set, and pattern, or it generates a cryptographically strong random surrogate token and records the cleartext-to-token mapping in its secure vault. When the client receives the response, it performs an in-memory swap of the cleartext value for the returned token, updates any associated indexes or checksums, and immediately forwards the sanitized record downstream. In some implementations, at no point is the sensitive cleartext written to disk or persisted in any cache; all transient buffers hold only the tokenized form. This tightly-coupled, real-time handshake ensures that the replication pipeline never exposes unprotected PII or PHI outside the confines of the data center and that all token mappings and encryption keys remain under strict vault control.

It will be appreciated after reading the present disclosure that “on-the-fly” generally refers to the well-known term, encompassing operations or processes that are performed dynamically and in real-time (or near-real-time), without the need for pre-processing or pre-computation; being done immediately as it is needed, rather than being prepared or stored ahead of time. For example, on-the-fly tokenization may refer to the process of dividing text into tokens (like words or subwords) as the text is being processed, rather than performing the tokenization step in advance.

In some implementations, data replication process 110 may compare 310 a replication key for the on-the-fly tokenization against a last stored value, shown also as step 7 on FIGS. 6 and 7. For instance, in some implementations, comparing a replication key for the on-the-fly tokenization against the last stored value may include hashing 336 a minimal set of business keys and change-timestamps. For example, traditional CDC engines tag each change event with a source-generated transaction identifier (TXID) or log sequence number, then rely on those TXIDs to drive ordering and deduplication. However, when millions of small TXID-labeled writes are sent in parallel to a cloud data warehouse, the target's micro-partitioning and concurrency controls can become overwhelmed, resulting in throttle errors or hotspots and ultimately slowing replication to a crawl. Thus, in some implementations, data replication process 110 may delegate change-event ordering and idempotence to a bespoke service that computes its own “replication key.” For each incoming record, the service extracts only the essential business-key columns (for example, a primary key or natural key set) combined with the event's commit timestamp. It then concatenates these values into a canonical string and passes them through a fast, fixed-length hash function (such as a truncated SHA-256). The resulting hash value replaces the source TXID as the key used to identify, partition, and de-duplicate change events.

Because every unique business-key/timestamp combination yields the same replication key, the loader of data replication process 110 can determine whether a change is new (INSERT) or an update to an existing record (UPDATE) without consulting the TXID. Furthermore, work is sharded by computing partition=hash(replicationKey) mod N, where N is the configured number of parallel writer threads. This approach limits concurrency to a manageable N streams, enough to fully leverage its scalability without floods of tiny TXID-based writes and can be dynamically adjusted by increasing or decreasing N. By decoupling change-stream semantics from the source database's internal logging and applying a deterministic, hash-based partitioning scheme, data replication process 110 achieves an exactly-once delivery, consistent ordering, and controlled parallelism within the target's operational constraints.

In some implementations, data replication process 110 may eliminate 312 at least the portion of the data when the replication key matches the last stored value. For example, when each mini-batch arrives, the delta framework of data replication process 110 first extracts the replication key for every record and then looks up the “last seen” hash for that key in a local state store (for example, an embedded RocksDB instance, Redis cache, or even a dedicated cloud staging table). Data replication process 110 then re-computes the hash over the record's business-key columns and commit timestamp. If the new hash differs from the stored value, the framework knows the underlying data truly changed: it checks whether this is the first time it's seeing that key (to distinguish INSERT vs. UPDATE), updates the state store with the new hash, and emits the appropriate DML event downstream. Conversely, if the hash matches the stored value, the framework concludes nothing material changed and silently drops the record. By performing this idempotent, per-key comparison before any cloud writes, the system guarantees that only net changes, rather than every log event, are applied, thereby preventing redundant writes, eliminating needless update storms, and keeping the target

### Warehouse Free of Superfluous Workload.

In some implementations, data replication process 110 may store 314 at least the portion of the data at the target when the replication key is different than the last stored value, shown also as step 8 on FIGS. 6 and 7. For instance, in some implementations, storing at least the portion of the data at the target when the replication key is different than the last stored value may include issuing 338 an insert into a live table for at least the portion of the data at the target, and issuing 340 an update into a live table for at least the portion of the data at the target. For example, once the downstream stream processor of data replication process 110 has filtered and tokenized changes, each batch is sent to a cloud-hosted microservice of data replication process 110 that applies the updates into the target database. For current-state use cases, data replication process 110 examines each incoming record's business key: if the key does not yet exist in the “live” table, it issues an INSERT; if it does exist, it issues an UPDATE to overwrite only the modified columns. This ensures the live table always reflects the most recent values with minimal DML overhead.

For full-history or Slowly Changing Dimension Type 2 (SCD 2) scenarios, data replication process 110 may take a two-step approach. When a change event arrives for an existing key, data replication process 110 first issues an UPDATE against the current row to set an “end_effective_timestamp” (or flip an “is_current” flag to false), thereby marking that row as expired. data replication process 110 then inserts a brand-new row containing the updated values with a fresh “start_effective_timestamp” and “is_current=true.” By chaining these timestamped records, the database maintains a complete audit trail of every historical version without overwriting past data.

After applying each batch, whether in current-state or SCD 2 mode, a validation framework may run automatically. data replication process 110 computes lightweight checksums (for example, CRC32 or MD5 hashes) over critical columns and compares row counts and hash aggregates between the source snapshot (taken at the same commit point) and the target table(s). Any discrepancy beyond a configurable tolerance (such as one row or a known interim lag) triggers an alert and re-scan of the affected partitions. Because data replication process 110 handles both merge logic and validation in-flight, end users need only query the live table for up-to-the-moment data or the history table for a full change log, no additional ETL or reconciliation jobs are required. This unified pattern streamlines analytics and reporting by providing immediate access to both the latest snapshot and a navigable timeline of every change.

The terminology used herein is for the purpose of describing particular implementations only and is not intended to be limiting of the disclosure. As used herein, the singular forms “a”, “an” and “the” are intended to include the plural forms as well, including any steps performed by a/the computer/processor, unless the context clearly indicates otherwise. As used herein, the phrase “at least one of A, B, and C” should be construed to mean a logical (A OR B OR C), using a non-exclusive logical OR, and should not be construed to mean “at least one of A, at least one of B, and at least one of C.” As another example, the language “at least one of A and B” (and the like) as well as “at least one of A or B” (and the like) should be interpreted as covering only A, only B, or both A and B, unless the context clearly indicates otherwise. It will be further understood that the terms “comprises” and/or “comprising,” when used in this specification, specify the presence of stated features, integers, steps (not necessarily in a particular order), operations, elements, and/or components, but do not preclude the presence or addition of one or more other features, integers, steps (not necessarily in a particular order), operations, elements, components, and/or groups thereof. Example sizes/models/values/ranges can have been given, although examples are not limited to

### The Same.

The terms (and those similar to) “coupled,” “attached,” “connected,” “adjoining,” “transmitting,” “communicating,” “receiving,” “connected,” “engaged,” “adjacent,” “next to,” “on top of,” “above,” “below,” “abutting,” and “disposed,” used herein is to refer to any type of relationship, direct or indirect, between the components in question, and may apply to electrical, mechanical, fluid, optical, electromagnetic, electromechanical or other connections, including logical connections via intermediate components (e.g., device A may be coupled to device C via device B). Additionally, the terms “first,” “second,” etc. are used herein only to facilitate discussion, and carry no particular temporal or chronological significance unless otherwise indicated. The terms “cause” or “causing” means to make, force, compel, direct, command, instruct, and/or enable an event or action to occur or at least be in a state where such event or action is to occur, either in a direct or indirect manner. The term “set” does not necessarily exclude the empty set-in other words, in some circumstances a “set” may have zero elements. The term “non-empty set” may be used to indicate exclusion of the empty set-that is, a non-empty set must have one or more elements, but this term need not be specifically used. The term “subset” does not necessarily require a proper subset. In other words, a “subset” of a first set may be coextensive with (equal to) the first set. Further, the term “subset” does not necessarily exclude the empty set-in some circumstances a “subset” may have zero elements.

The corresponding structures, materials, acts, and equivalents (e.g., of all means or step plus function elements) that may be in the claims below are intended to include any structure, material, or act for performing the function in combination with other claimed elements as specifically claimed. While the disclosure describes structures corresponding to claimed elements, those elements do not necessarily invoke a means plus function interpretation unless they explicitly use the signifier “means for.” Unless otherwise indicated, recitations of ranges of values are merely intended to serve as a shorthand way of referring individually to each separate value falling within the range, and each separate value is hereby incorporated into the specification as if it were individually recited. While the drawings divide elements of the disclosure into different functional blocks or action blocks, these divisions are for illustration only. According to the principles of the present disclosure, functionality can be combined in other ways such that some or all functionality from multiple separately-depicted blocks can be implemented in a single functional block; similarly, functionality depicted in a single block may be separated into multiple blocks. Unless explicitly stated as mutually exclusive, features depicted in different drawings can be combined consistent with the principles of the present disclosure. Moreover, although this disclosure describes and depicts respective implementations herein as including particular components, elements, feature, functions, operations, or steps (and arrangements thereof), any of these implementations may include any combination, arrangement, or permutation of any of the components, elements, features, functions, operations, or steps described or depicted anywhere herein that a person having ordinary skill in the art would comprehend after reading the present disclosure. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

The description of the present disclosure has been presented for purposes of illustration and description but is not intended to be exhaustive or limited to the disclosure in the form disclosed. After reading the present disclosure, many modifications, variations, substitutions, and any combinations thereof will be apparent to those of ordinary skill in the art without departing from the scope and spirit of the disclosure. The implementation(s) were chosen and described in order to explain the principles of the disclosure and the practical application, and to enable others of ordinary skill in the art to understand the disclosure for various implementation(s) with various modifications and/or any combinations of implementation(s) as are suited to the particular use contemplated. The features of any dependent claim may be combined with the features of any of the independent claims or other dependent claims.

Having thus described the disclosure of the present application in detail and by reference to implementation(s) thereof, it will be apparent that modifications, variations, and any combinations of implementation(s) (including any modifications, variations, substitutions, and combinations thereof) are possible without departing from the scope of the disclosure defined in the appended claims.

1. A computer-implemented method, comprising:
receiving, by a computing device, data from a source;
defining how the data maps to a target that is remote from the source;
monitoring at least a portion of the data for change events, including allocating a plurality of worker threads to process distinct partitions of the change events in parallel, wherein change events within each partition are processed sequentially in an original commit order of the change events;
scanning at least the portion of the data for the change events to identify sensitive elements;
providing on-the-fly tokenization of at least the portion of the data for the change events identified as the sensitive elements;
comparing a replication key for the on-the-fly tokenization against a last stored value;
eliminating at least the portion of the data when the replication key matches the last stored value; and
storing at least the portion of the data at the target when the replication key is different than the last stored value.

2. The computer-implemented method of claim 1 further comprising batch processing the change events into configurable chunks.

3. The computer-implemented method of claim 2, wherein the configurable chunks are configurable by at least one of row batches and intervals.

4. The computer-implemented method of claim 2, wherein the batch processing pauses reads if a next stage is busy.

5. The computer-implemented method of claim 2, wherein the batch processing replays failed batches using an exactly-once token.

6. The computer-implemented method of claim 2, wherein the batch processing maintains event ordering per partition.

7. The computer-implemented method of claim 1, wherein monitoring at least the portion of the data for change events includes generating a subscription for the change events.

8. The computer-implemented method of claim 7, wherein monitoring at least the portion of the data for the change events includes creating a change-stream definition to identify at least the portion of the data to monitor for changes.

9. The computer-implemented method of claim 1, wherein scanning at least the portion of the data for the change events to identify the sensitive elements includes flagging the sensitive elements using machine learning based classifiers to detect sensitive fields.

10. The computer-implemented method of claim 1, wherein scanning at least the portion of the data for the change events to identify the sensitive elements includes flagging the sensitive elements using pattern recognition for known ID formats to detect sensitive fields.

11. The computer-implemented method of claim 1, wherein scanning at least the portion of the data for the change events to identify the sensitive elements includes flagging the sensitive elements using context-aware classifiers to detect sensitive fields.

12. The computer-implemented method of claim 1, wherein providing on-the-fly tokenization of at least the portion of the data for the change events identified as the sensitive elements includes triggering a tokenization application programming interface (API) in real-time.

13. The computer-implemented method of claim 1, wherein providing on-the-fly tokenization of at least the portion of the data for the change events identified as the sensitive elements includes selecting a format-preserving encryption.

14. The computer-implemented method of claim 1, wherein providing on-the-fly tokenization of at least the portion of the data for the change events identified as the sensitive elements includes selecting a random surrogate token stored in a vault.

15. The computer-implemented method of claim 1, wherein providing on-the-fly tokenization of at least the portion of the data for the change events identified as the sensitive elements includes eliminating persistent cleartext copies.

16. The computer-implemented method of claim 1, wherein comparing a replication key for the on-the-fly tokenization against the last stored value includes hashing a minimal set of business keys and change-timestamps.

17. The computer-implemented method of claim 1, wherein storing at least the portion of the data at the target when the replication key is different than the last stored value includes issuing an insert into a live table for at least the portion of the data at the target.

18. The computer-implemented method of claim 1, wherein storing at least the portion of the data at the target when the replication key is different than the last stored value includes issuing an update into a live table for at least the portion of the data at the target.

19. A computer program product residing on a non-transitory computer readable storage medium having a plurality of instructions stored thereon which, when executed across one or more processors, causes at least a portion of the one or more processors to perform operations comprising:
receiving, by a computing device, data from a source;
defining how the data maps to a target that is remote from the source;
monitoring at least a portion of the data for change events, including allocating a plurality of worker threads to process distinct partitions of the change events in parallel, wherein change events within each partition are processed sequentially in an original commit order of the change events;
scanning at least the portion of the data for the change events to identify sensitive elements;
providing on-the-fly tokenization of at least the portion of the data for the change events identified as the sensitive elements;
comparing a replication key for the on-the-fly tokenization against a last stored value;
eliminating at least the portion of the data when the replication key matches the last stored value; and
storing at least the portion of the data at the target when the replication key is different than the last stored value.

20. A computing system including one or more processors and one or more memories, the one or more memories having a plurality of instructions stored thereon which, when executed across the one or more processors, causes at least a portion of the one or more processors to perform operations comprising:
receiving, by a computing device, data from a source;
defining how the data maps to a target that is remote from the source;
monitoring at least a portion of the data for change events, including allocating a plurality of worker threads to process distinct partitions of the change events in parallel, wherein change events within each partition are processed sequentially in an original commit order of the change events;
scanning at least the portion of the data for the change events to identify sensitive elements;
providing on-the-fly tokenization of at least the portion of the data for the change events identified as the sensitive elements;
comparing a replication key for the on-the-fly tokenization against a last stored value;
eliminating at least the portion of the data when the replication key matches the last stored value; and
storing at least the portion of the data at the target when the replication key is different than the last stored value.
